(19) United States
(12) Patent Application Publication
(10) Pub. No.: US 2020/0304403 A1
(43) Pub. Date: Sep. 24, 2020

(54) NETWORK ROUTE OPTIMIZATION USING EXCESS PRIVATE NETWORK CAPACITY

(71) Applicant: Network Next, Inc., Santa Monica, CA (US)

(72) Inventor: Glenn Fiedler, Santa Monica, CA (US)

(21) Appl. No.: 16/823,176

(22) Filed: Mar. 18, 2020

Related U.S. Application Data
(60) Provisional application No. 62/821,188, filed on Mar. 20, 2019.

(51) Int. Cl. H04L 12/725; H04L 12/717; H04L 12/707; H04L 12/727; H04L 12/14; H04L 12/46; H04L 12/26

(52) U.S. Cl. CPC H04L 45/302; H04L 45/42; H04L 45/24; H04L 45/121; H04L 43/0894; H04L 12/4641; H04L 43/0817; H04L 43/087; H04L 12/14

(57) ABSTRACT

A system and computer program product for routing based on user preferences comprising, receiving a routing request from a client device wherein the routing request includes a desired route price and reliability preferences. Determining a plurality of potential packet routes from the routing request and sending a query for potential packet route information to one or more relays in the plurality of potential packet routes. Receiving potential packet route information from each of the one or more relays in the plurality of potential routes and automatically determining an optimal potential packet route based at least on the desired route price, and reliability preferences information.

### CLAIM OF PRIORITY

This application claims the priority benefit of U.S. Provisional Patent Application No. 62/821,188 filed Mar. 20, 2019, the entire contents of which are incorporated herein by reference.

### FIELD OF THE INVENTION

Aspects of the present disclosure are related packet route optimization. Specifically aspects of the present disclosure are related to optimizing packet routes based on reliability and user price preferences.

### BACKGROUND

The internet was not designed for real-time traffic. The public internet is optimized for maximum throughput at lowest cost. Infrastructure owners are not incentivized to address or fix this problem. As a result, congestion and traffic leads to bad user experiences. The real-time traffic of many newer applications profoundly suffers because of this.

One example of a real time application that suffers due to the poorly optimized public internet is video games. Currently, video game traffic is routed across a series of providers who fundamentally misunderstand that games are different to static content like email, websites, images and movies. Video games require updates from servers to clients and vice versa that happen at near instantaneous real-time speed.

While infrastructure owners have had twenty years to find a solution to solve this problem—there is a pervasive orthodoxy on the internet that ‘all traffic is the same.’ The problem is that real-time traffic is fundamentally different from regular internet traffic and infrastructure owners have had no incentive to address this problem or even engage in the issue at all.

The growth of the games industry, and the emergence of real-time application needs, has led to a sufficient volume of traffic that the aging poorly optimized public internet is no longer sufficient to meet the needs of the public.

Private companies on the other hand have spent massive amounts of capital investing in infrastructure to support private networks for services such as content delivery (CDNs) or site to site communication. These private networks are connected to the internet but are not available to the public. Many private networks are underutilized meaning that there are large amounts of unused bandwidth hidden from the public consumer.

Thus, there is a need for a way to safely connect and route public consumer network traffic to otherwise unavailable private networks in a way that allows for efficient compensation for private network operators and competition between private network operators.

### BRIEF DESCRIPTION OF THE DRAWINGS

The teachings of the present disclosure can be readily understood by considering the following detailed description in conjunction with the accompanying drawings, in which:

FIG. 1 is a block diagram of a network route optimization scheme using private network capacity according to an aspect of the present disclosure.

FIG. 2 is a block diagram showing a method for network route optimization using private network capacity for a host server according to aspects of the present disclosure.

FIG. 3 is a block diagram showing a method for network route optimization using private network capacity for a client device according to aspects of the present disclosure

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

In the interest of clarity, not all of the routine features of the implementations described herein are shown and described. It will be understood by those skilled in the art that in the development of any such implementations, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of the present disclosure.

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

In accordance with aspects of the present disclosure, the components, process steps, and/or data structures may be implemented using various types of operating systems; computing platforms; user interfaces/displays, including personal or laptop computers, video game consoles, PDAs and other handheld devices, such as cellular telephones, tablet computers, portable gaming devices; and/or general purpose machines. In addition, those of ordinary skill in the art will recognize that devices of a less general purpose nature, such as hardwired devices, field programmable gate arrays (FOGs), application specific integrated circuits (ASICs), or the like, may also be used without departing from the scope and spirit of the inventive concepts disclosed herein.

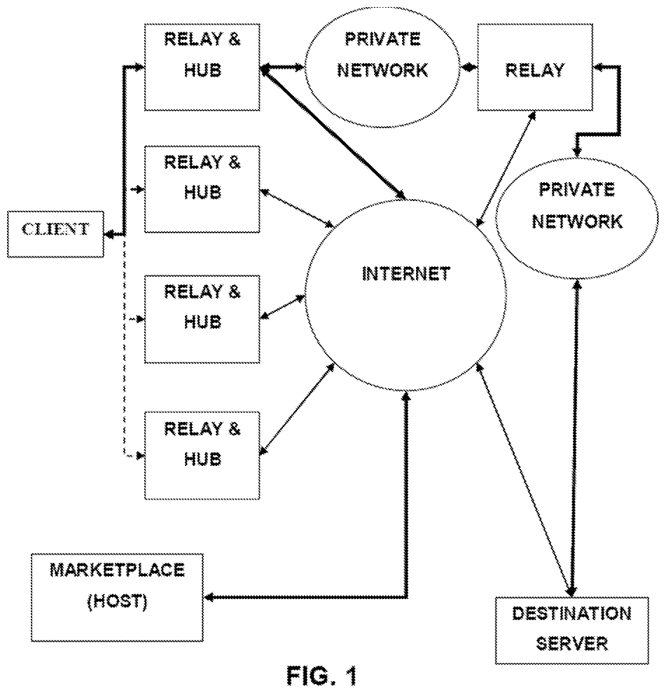

FIG. 1 shows a block diagram of a network route optimization scheme using excess private network capacity according to aspects of the present disclosure. Generally clients connected to the internet may have traffic routed through many different local network lines before reaching a network hub. Network hubs connect local networks to other network lines that span the world between major cities and other outlying areas. A network hub may be an Internet Exchange Point (IXP), Network Access point (NAP), Commercial Internet Exchange (CIX) or the like. Depending on location, Internet service provider and network conditions, among other factors there may be multiple different network hubs available to the client.

According to aspects of the present disclosure, these network hubs may have a relay device that allows packets to from the client devices to be routed to private networks also connected to the network hub. A host server in communication with the client device may enable the client device to send packets over these private networks using the relays. Ordinarily the private networks would not be accessible to client and packets sent by the client would have to travel through the ordinary internet networks to reach a destination server. The host server may be connected to the internet to communicate with the client. The client device sends a routing request for a destination server to the host server. The host server communicates with the available private networks and determines the best route from the private networks and the internet for the client to send packets. The host server then sends the encrypted route to the client and the client then uses that route to send packets. The destination server may use that same route to return packets while the connection is established. The optimal route may be through multiple private networks or through private networks and the public internet. The Host server may periodically reassess the optimal route for packets sent by the client to the destination server. For example the host server my reassess network conditions of the private networks and the public internet every 10 seconds to determine whether the previously chosen optimal route remains optimal.

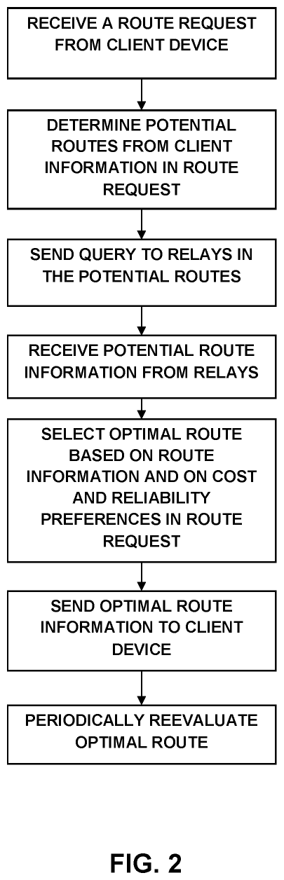

FIG. 2 is a block diagram of the method of operation of the host server according to aspects of the present disclosure. The host server receives a route request from a client device. The route request may include the physical location of the client device, a packet destination, the nearest network hubs having relays, network metrics for the connections between to the client device and the nearest network hubs having relays, user preferences for desired route price and connection reliability. By way of example and without limitation Network metrics and connection reliability preferences may include network jitter, network latency, and packet drop rate. The nearest networks hubs may for example and without limitation be the nearest 10 network hubs. Once the route request is received the host server may determine potential packet routes from the routing request. The host server may then send a query for potential packet route information to the relays in the potential packet routes. The potential packet route information may include for example and without limitation, private network provider price, network metrics for connections between relays over the private networks and/or through the public internet. Each of the queried relays may then respond by sending the determined potential route information back to the host server.

Alternatively, the host server may periodically query every relay for potential packet route information. The host server may maintain a database of all the potential packet route information and in response to receiving a route request, determine potential packet routes and look up the potential route information from the database. In some embodiments, a private provider network price may be determined from a look-up table.

After the host server has received potential packet route information and determined the potential packet routes for the client to send to the destination, the host server may determine the optimal packet route. To determine the optimal packet route the host server may use the user preferences of the desired route price and reliability. The host server may compare the desired route price and reliability preferences to the potential packet route information including private network provider price. The host server may automatically choose the optimal packet route, that is, a packet route that has potential route information that best matches the user preferences of desired route prices and reliability. In some embodiments, for the comparison, the host server may sum the potential route information for each network the packets will travel to reach their destination.

Once the optimal route information is chosen, it is encrypted in and sent to client device. For more information on the encryption and packet routing systems see commonly owned pending U.S. patent application Ser. No. 15/974,305, filed May 8, 2018 and published as U.S. Patent Application Publication Number 2018/0255036, the contents of which are incorporated herein by reference and bodily incorporated herein as Appendix A.

Additionally, after the optimal route is chosen the host server may periodically repeat the above-described process to reassess the packet routes. If a new optimal route that is different from a previous optimal route is found the host server may send an encrypted new optimal route to the client which will use new optimal for route for all subsequent packets until it receives another update from the host server.

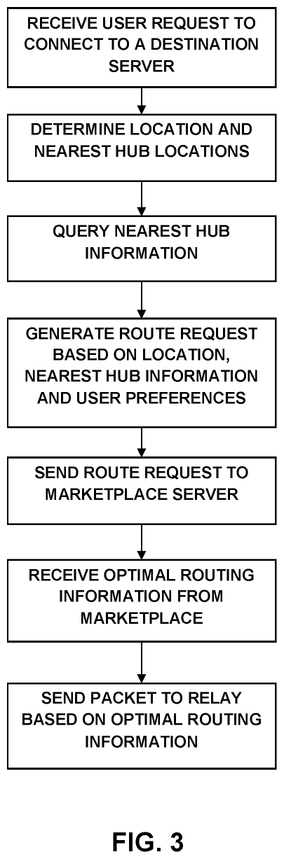

FIG. 3 is a block diagram of the method of operation of the client device according to aspects of the present disclosure. A client device may receive a request from a user to connect to a destination. The request to connect to a destination may include user preferences such as a desired route price and reliability preference. This request may be received through a user interface, remotely from another device or some other control mechanism. The client device may then determine its physical location. Determining the client device physical location may be performed using by way of example and without limitation, a global positioning system (GPS), nearest cellphone tower location determination, internet protocol address lookup or similar. Additionally the client device may determine the nearest network hub and send a query requesting nearest hub information including network metrics to each hub having a relay, to determine network metrics for each of the nearest network hubs having a relay.

From the nearest hub information, packet destination, client device location and preferences set by the user including desired route price and reliability, the client device generates a route request. The route request is sent to the host server, which determines the optimal route based on the information in route request. The host server sends the optimal potential route to the client device.

Once the optimal potential route is received from the host server, the optimal routing information is used to send packets to the destination. For more information regarding sending packets with the optimal route information see pending U.S. patent application Ser. No. 15/974,305, filed May 8, 2018 and published as U.S. Patent Application Publication Number 2018/0255036, the contents of which are incorporated herein by reference and bodily incorporated herein as Appendix A.

The host server may periodically reassess the optimal packet route and send new optimal potential packet routes to the client device. After receipt of a new optimal potential packet route the client device may send subsequent packets using the new optimal packet route information.

While the above is a complete description of the preferred embodiments of the present invention, it is possible to use various alternatives, modifications, and equivalents. Therefore, the scope of the present invention should be determined not with reference to the above description but should, instead, be determined with reference to the appended claims, along with their full scope of equivalents. Any feature, whether preferred or not, may be combined with any other feature, whether preferred or not. In the claims that follow, the indefinite article “A” or “An” refers to a quantity of one or more of the item following the article, except where expressly stated otherwise. The appended claims are not to be interpreted as including means-plus-function limitations, unless such a limitation is explicitly recited in a given claim using the phrase “means for”. Any element in a claim that does not explicitly state “means for” performing a specified function, is not to be interpreted as a “means” or “step” clause as specified in 35 USC § 112, ¶6.

What is claimed is:

1. A system for routing based on user preferences comprising:
a processor;
memory coupled to the processor;
non-transitory instructions embedded in memory that when executed cause the processor to carry out the method comprising:
a) receiving a routing request from a client device wherein the routing request includes a desired route price and reliability preferences;
b) determining a plurality of potential packet routes from the routing request;
c) sending a query for potential packet route information to one or more relays in the plurality of potential packet routes;
d) receiving potential packet route information from each of the one or more relays in the plurality of potential routes;
e) automatically determining an optimal potential packet route based at least on the desired route price, and reliability preferences information.

2. The system of claim 1 wherein the potential packet route information includes a private network operator price.

3. The system of claim 1 wherein the optimal potential packet route is automatically determined periodically.

4. The system of claim 1 wherein the potential packet route information includes a network performance metric.

5. The system of claim 1, further comprising f) encrypting the optimal potential packet route and g) sending the optimal potential packet route to the client device.

6. The system of claim 1 wherein the routing request further includes a location of the client device and network performance metrics for one or more closest network hubs.

7. The system of claim 6 wherein the one or more closest network hubs include a closest 10 network hubs that that include one of the one or more relays.

8. The system of claim 1 wherein automatically determining the optimal potential packet route further comprises using a look up table to determine a private network operator price for the each of the potential packet routes.

9. The system of claim 1 wherein the reliability preferences include network jitter, latency, packet loss or some combination thereof.

10. The system of claim 1 wherein the network performance metrics include network jitter, latency, packet loss or some combination thereof.

11. Non-transitory instructions embedded in memory that when executed cause a processor to carry out the method comprising:
a) receiving a routing request from a client device wherein the routing request includes a desired route price and reliability preferences;
b) determining a plurality of potential packet routes from the routing request;
c) sending a query for potential packet route information to one or more relays in the plurality of potential packet routes;
d) receiving potential packet route information from each of the one or more relays in the plurality of potential routes;
e) automatically determining an optimal potential packet route based at least on the desired route price, reliability preferences information.

12. Non-transitory instructions embedded in memory that when executed cause a processor to carry out the method comprising
a) determining a current location and the network performance metrics for one or more closest network hubs having relays;
b) receiving a desired price and a reliability preference from a user;
c) sending the current location, the network performance metrics for one or more closest network hubs having relays, desired prices and reliability preferences to a marketplace server;
d) receiving encoded optimal potential packet route from marketplace server;
e) sending packets using the encoded optimal potential packet route information.
